(19) United States
(12) Patent Application Publication
(10) Pub. No.: US 2014/0124229 A1
(43) Pub. Date: May 8, 2014

(54) IMPACT TOOL

(71) Applicants: Shigeru Takahashi, Hitachinaka (JP); Katsuhiro Oomori, Hitachinaka (JP)

(72) Inventors: Shigeru Takahashi, Hitachinaka (JP); Katsuhiro Oomori, Hitachinaka (JP)

(73) Assignee: HITACHI KOKI CO., LTD., Tokyo (JP)

(21) Appl. No.: 14/129,924

(22) PCT Filed: Aug. 30, 2012
(86) PCT No.: PCT/JP2012/005493

§ 371 Date: Dec. 27, 2013

(30) Foreign Application Priority Data
Oct. 31, 2011 (JP) 2011-238172

(51) Int. Cl. B25B 21/02

(52) U.S. Cl. CPC B25B 21/02
USPC 173/93.5

(57) ABSTRACT

An impact tool has a hammer (5) to be driven by a motor for revolution and an anvil (6) impacted with the revolution by the hammer (5) and transmitting an impact force to a tip tool. Between the motor and the hammer (5), first and second ring gears (41A, 42A) are provided, and first and second planetary gear mechanisms (41) and (42) are arranged to transmit the rotary force of the motor to the hammer (5). The motor, the hammer (5), the anvil (6), and the first and second ring gears (41A, 42A) are accommodated in a housing (2). The second ring gear (42A) is movable between a holding position where the second ring gear (42A) is held as being engaged with the housing (2) and a non-holding position where the second ring gear (42A) is not engaged with the housing (2) and is revolvable with respect to the housing (2).

### TECHNICAL FIELD

The present invention relates to an impact tool. More particularly, the present invention relates to an impact tool generating an impact force by revolution control over a motor.

### BACKGROUND ART

Traditionally, impact tools for fastening screw members such as nuts and bolts have been known. An impact tool of this type includes, by way of example, a structure for transmitting an impact force in a revolving direction to a screw member by a revolving impact force of a hammer. The impact tool having this structure includes a motor, a hammer to be driven by the motor, an anvil to be impacted by the hammer and holding a tip tool, that is, an impacting (striking) tool.

In the impact tool, the motor installed in a housing is driven by using power supplied from a rechargeable battery or power externally supplied from a power supply cord, the hammer is revolved by the motor via a deceleration mechanism unit, and the anvil is impacted by the revolving hammer for fastening. In more detail, as disclosed in Patent Literature 1, a brushless motor is used as a motor, and forward and reverse revolutions are repeatedly performed by duty control within a microtime, thereby revolving the hammer forwardly or in reverse to produce an impact force on the anvil. In this impact tool, since revolution control over the motor is performed by duty control, the number of revolutions of the anvil where the tip tool is mounted is calculated from a value obtained by multiplying the number of revolutions of the motor by a speed reducing ratio of the deceleration mechanism unit.

### CITATION LIST

### Patent Literature

PTL 1: Japanese Patent Application Laid-Open Publication No. 2011-31314

### SUMMARY OF INVENTION

### Technical Problem

However, depending on the material of a member to be processed or the type of screw or the like to be fastened, the number of revolutions of the tip tool may be desired to be decreased or increased more.

A preferred aim of the present invention is to provide an impact tool capable of controlling the number of revolutions of a tip tool in a wider range.

### Solution to Problem

An impact tool of the present invention includes: a motor; a hammer to be driven by the motor for revolution; an anvil impacted with the revolution by the hammer and transmitting an impact force to a tip tool; a plurality of planetary gear mechanisms interposed between the motor and the hammer, each having a ring gear, and transmitting a rotary force of the motor to the hammer; and a housing holding the motor, the hammer, the anvil, and each of the ring gears. Among the ring gears, at least one ring gear is configured movably to move between a holding position where the ring gear is engaged with and held by the housing and a non-holding position where the ring gear is not engaged with the housing and is able to revolve with respect to the housing.

When the ring gear is set at the holding position, the planetary gear mechanism having the one ring gear is decelerated to transmit a rotary force to the anvil. On the other hand, when the ring gear is set at the non-holding position, the planetary gear mechanism having the one ring gear is not decelerated and a rotary force is transmitted to the anvil. In this manner, the speed reducing ratio can be changed in two levels, that is, the holding position and the non-holding position of the ring gear.

Preferably, the housing of the impact tool has an engaging unit engaging with the one ring gear, the one ring gear has an engaged unit engaging with the engaging unit, and the engaging unit and the engaged unit are configured so as to be engaged with each other at the holding position and become unable to be engaged with each other at the non-holding position. In this impact tool, the ring gear can be reliably made unable to revolve at the holding position with respect to the housing, and the ring gear can be made revolvable at the non-holding position with respect to the housing.

Preferably, the impact tool further has an operating unit capable of operating the ring gear between the holding position and the non-holding position, and the operating unit is exposed to an outer surface of the housing. In this impact tool, the ring gear can be easily switched by the operating unit between the holding position and the non-holding position.

The ring gear is preferably included in a planetary gear mechanism that directly drives the hammer for revolution among the plurality of planetary gear mechanisms. In this impact tool, the ring gear is switched between the holding position and the non-holding position in the planetary gear mechanism with the lowest number of revolutions, and therefore switching is easy.

Preferably, the motor is a brushless motor, the impact tool further includes a control unit for revolution control over the motor, and the control unit is configured to be able to change the revolution control with the one ring gear being provided at the holding position and the non-holding position, respectively. In this impact tool, optimum revolution control can be performed over the motor when an impact operation is performed at a different speed reducing ratio.

Preferably, the impact tool further has a detecting device that detects a position of the one ring gear at the holding position and the non-holding position, and the control unit performs the revolution control based on the detection result of the detecting device. In this impact tool, the holding position and the non-holding position can be easily detected by the control unit.

### Advantageous Effects of Invention

According to the impact tool of the present invention, the number of revolutions of the tip tool can be controlled in a wider range.

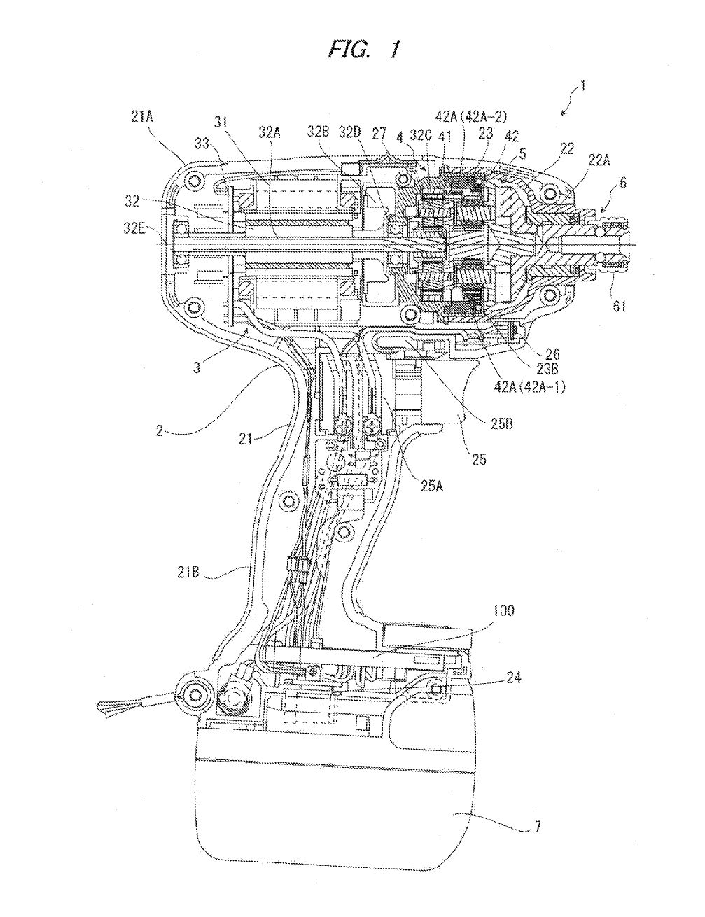

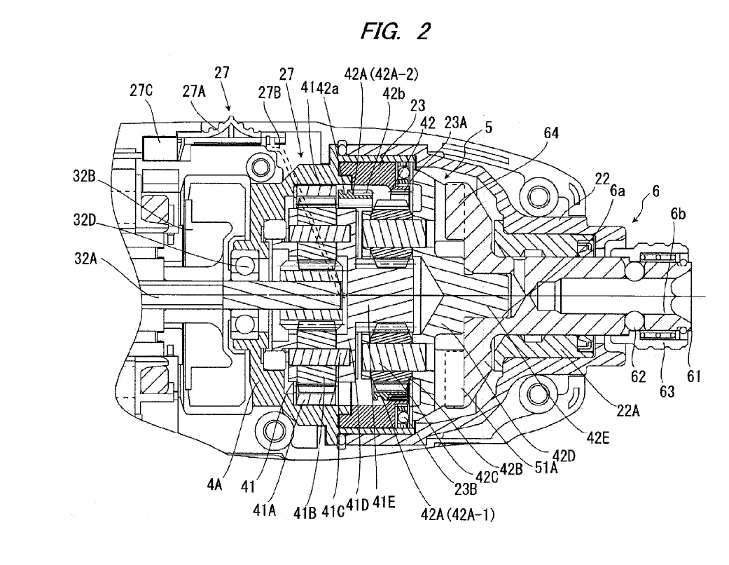

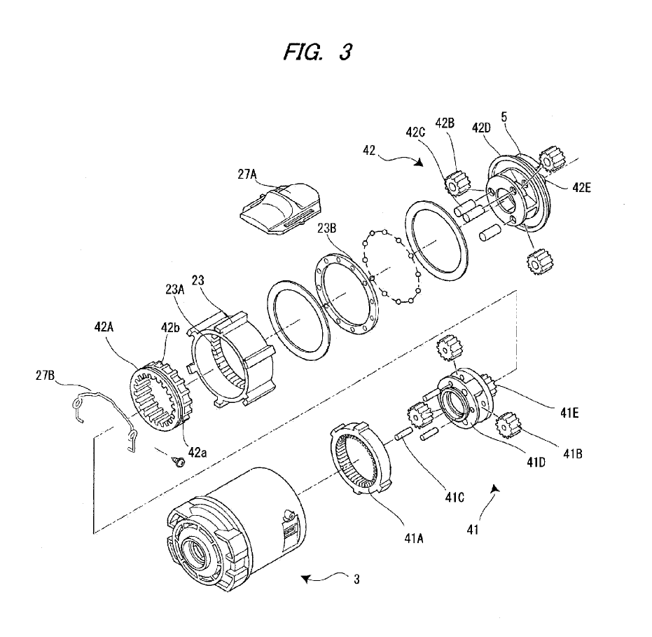

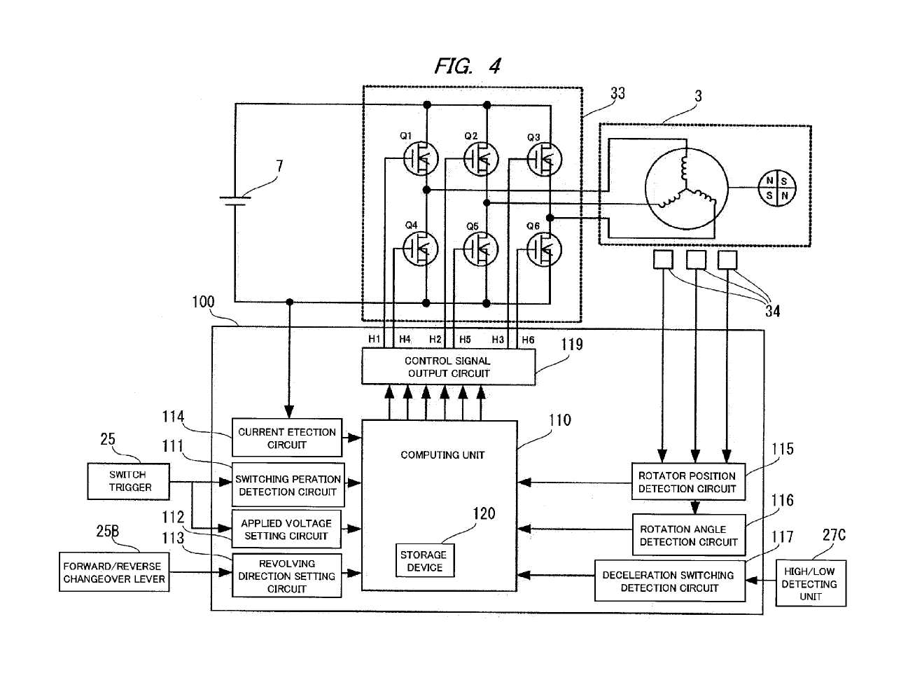

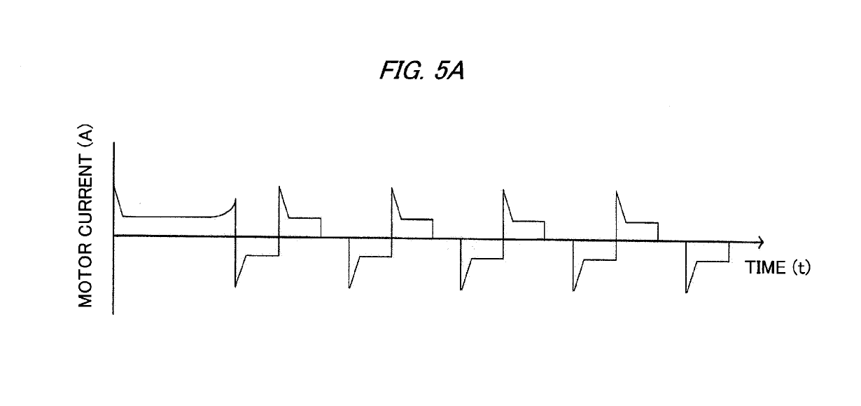

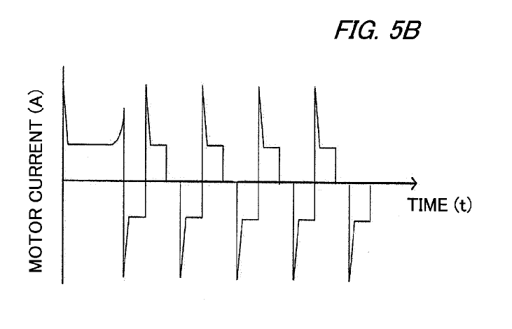

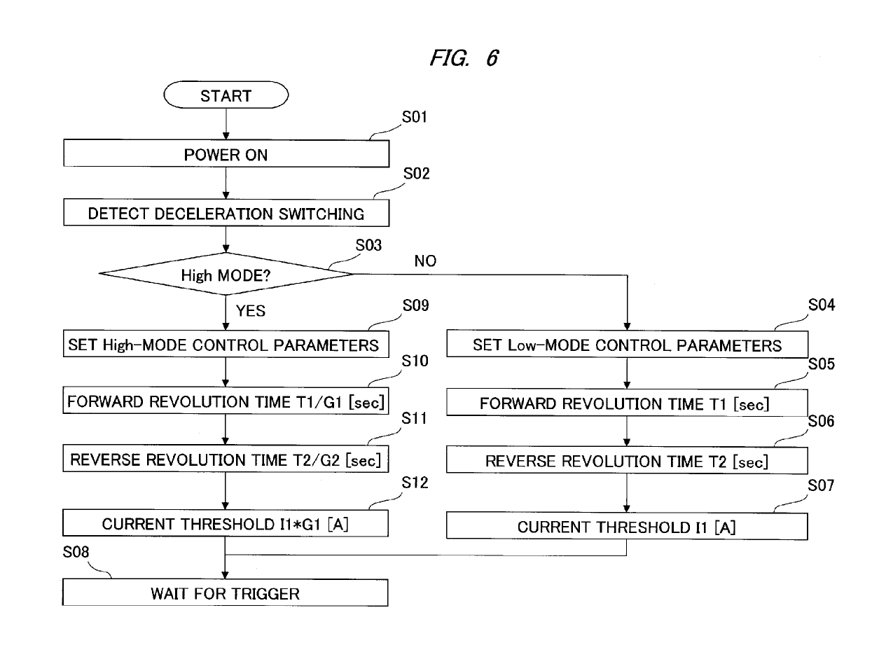

### BRIEF DESCRIPTION OF DRAWINGS

[FIG. 1] FIG. 1 is a sectional view of an impact tool according to an embodiment of the present invention.

[FIG. 2] FIG. 2 is an enlarged sectional view of a part of FIG. 1.

[FIG. 3] FIG. 3 is an exploded perspective view of a deceleration mechanism in the impact tool illustrated in FIG. 1.

[FIG. 4] FIG. 4 is control circuit view of the impact tool.

[FIG. 5A] FIG. 5A is a graph illustrating timings of impact of the impact tool according to the embodiment of the present invention at a holding position.

[FIG. 5B] FIG. 5B is a graph illustrating timings of impact of the impact tool according to the embodiment of the present invention at a non-holding position.

[FIG. 6] FIG. 6 is a flowchart of changes of impact timings of the impact tool according to the embodiment of the present invention.

### DESCRIPTION OF EMBODIMENTS

An embodiment of the impact tool according to the present invention will be described with reference to FIGS. 1 to 6. As illustrated in FIG. 1, specifically, an impact tool 1 is used to fasten a bolt, a nut, or a tapping screw such as a wood screw. The impact tool 1 is mainly configured of a housing 2, a motor 3, a gear mechanism 4, a hammer 5, and an anvil 6, and the motor 3 is driven with a chargeable battery 7 as a power supply. When a nut or a bolt as a screw member is fastened, a load for revolution hardly exerts on the anvil at the start of fastening, and the load abruptly increases immediately before the completion of fastening. By contrast, when a tapping screw as a screw member is fastened, the revolution load is added to the anvil from the start of fastening.

The housing 2 is mainly configured of a main housing 21, a hammer case 22, and an engaging unit 23. The main housing 21 is a resin housing made of nylon 6, and includes a body unit 21A having the motor 3 and others accommodated therein and also having the hammer case 22 embedded therein, and a handle 21B extending from the body unit 21A. The body unit 21A and the handle 21B have an accommodation space defined therein, and the housing 2 is configured of housing pieces approximately symmetrical to each other, the housing pieces dividing the housing into two with planes extending in vertical and longitudinal directions, which will be described further below. The accommodation space has a portion therein corresponding to the inside of the body unit 2, the portion where the motor 3, gear mechanism 4, hammer 5, and anvil 6 described above are coaxially arranged in a line from one end side to the other end side. An axial direction in which these motor 3, gear mechanism 4, hammer 5, and anvil 6 are arranged in a line is defined as the longitudinal direction, with a motor 3 side being taken as a rear side. Also, a direction orthogonal to the longitudinal direction is defined as the vertical direction, with a direction in which the handle 21B extends from the body unit 21A being taken as a downward direction, and a direction orthogonal to the longitudinal direction and the vertical direction is defined as a horizontal direction, taking an upside of FIG. 1 as a right direction.

In the body unit 21A, an exhaust port and an air-intake port not shown are formed at forward and rearward positions of the motor 3 and left and right side surface positions of the body unit 21A. In the main housing 21, a terminal unit 24 having the battery 7 mounted thereon and electrically connected thereto is arranged at a lower end position of the handle 21B. In an upper portion of the terminal unit 24, a control circuit unit 100 is arranged, controlling revolution of the motor 3 and light irradiation of an irradiating unit 26, which will be described further below. At a base portion of the handle 21B, a trigger 25 to be operated by an operator is provided, and a switching unit 25A connected to the trigger 25 and the control circuit unit 100 is also provided to control conduction to the motor 3. By operating the trigger 25, switching is made between supply and stop of power to a motor driving circuit device 33, which will be described further below. Also, at the base portion of the handle 21B and above the trigger 25, a forward/reverse switching lever 25B switching the revolving direction of the motor 3 is provided.

In the housing 2, at its front end and below the hammer 5, the irradiating unit 26 connected to the control circuit unit 100 and having an LED for irradiation toward the front side (the tip side of the tip tool) is provided.

The hammer case 22 is made of a metal, formed in a cylindrical shape with a tapered front end, and arranged at a front end position in the body unit 21A. A front end portion of the hammer case 22 is exposed from the front end of the body unit 21A toward the front, and a rear end portion thereof is connected to the body unit 21A so as to be coaxial with the motor 3. At the front end portion of the hammer case 22, a bearing 22A that rotatably supports the anvil 6 is provided.

As illustrated in FIG. 3, the engaging unit 23 is configured in a coronary shape, provided with six projections equidistantly around its outer circumference and, as illustrated in FIG. 2, inserted in the hammer case 22 so that a second ring gear 42A, which will be described further below, is positioned inside the coronary shape. With the plurality of projections described above being fixed to the hammer case 22, the engaging unit 23 is configured so as to be unable to move forward or backward or revolve. A convex part 23A is provided at a front end position on an inner circumferential surface of the engaging unit 23 and at the front of an outer circumferential portion of the second ring gear 42A, which will be described further below. The convex part 23A is configured of a plurality of ridge-shaped projections equidistantly arranged in a circumferential direction of the inner circumferential surface of the engaging unit 23 and extending toward the rear.

A thrust bearing 23B is arranged on a front end surface of the engaging unit 23 to receive a rear surface of a second planet carrier 42D, which will be described further below, integrally formed with the hammer 5. With the second planet carrier 42D being received by this thrust bearing 23B, transmission of a stress in an axial direction occurring in the anvil 6 and the hammer 5 to a first planetary gear mechanism 41, which will be described further below, the motor 3, and others is suppressed.

The body unit 21A is provided with an operating unit 27 that can operate the second ring gear 42A, which will be described further below, in the longitudinal direction. The operating unit 27 is configured of an operation knob 27A, an engaging unit 27B mounted on the operation knob 27A, and a high/low detecting unit 27C. The operation knob 27A is supported to the body unit 21A so as to be able to move forward and backward and is exposed to an outer surface of the body unit 21A in an upper portion of the body unit 21A. As illustrated in FIG. 3, the engaging unit 27B is configured of a wire bent in an approximately C shape, and has both ends of the C shape connected to the second ring gear 42A, which will be described further below. As illustrated in FIG. 2, the high/low detecting unit 27C is configured of a microswitch and arranged at the rear of the operation knob 27A. Detecting that the operation knob 27A has moved rearward, the high/low detecting unit 27C outputs the detection to the control circuit unit 100.

As illustrated in FIG. 1, the motor 3 is a DC brushless motor, and mainly includes a stator 31, a rotor 32, and the motor driving circuit device 33. The stator 31 is configured in a cylindrical shape to form an outer shell of the motor 3, has a coil not shown formed therein, and has an outer circumferential surface held by the main housing 21.

The rotor 32 is arranged so as to be able to revolve in the stator 31, and is provided with a rotor shaft 32A at a rotating axis position, the rotor shaft 32A extending in a longitudinal direction so as to coaxially and integrally revolve with the rotor 32. At a front end of the rotor shaft 32A, a fan 32B and a first pinion gear 32C are mounted so as to coaxially and integrally revolve with the rotor shaft 32A, and a bearing 32D is also mounted so as to be supported by a frame body 4A, which will be described further below. At a rear end of the rotor shaft 32A, a bearing 32E is mounted to support the rotor shaft 32A to the body unit 21A. With these bearings 32D and 32E, the rotor shaft 32A is supported so as to be able to revolve. With the rotor shaft 32A and the fan 32B integrally revolving, an air flow passing from the air-intake port not shown through the accommodation space in the body unit 21A to the exhaust port not shown.

The motor driving circuit device 33 having a circuit substrate is arranged at the rear of the stator 31 and fixed to the stator 31. The motor driving circuit device 33 includes a plurality of switching elements Q1 to Q6 (FIG. 4). With a coil not shown of the stator 31 being energized, the revolution of the rotor 32 is controlled.

In the body unit 21A, the gear mechanism 4 is arranged at the front side of the motor 3. As illustrated in FIG. 2, the gear mechanism 4 is configured of the first planetary gear mechanism 41 and a second planetary gear mechanism 42, using the frame body 42A as an outer shell.

The first planetary gear mechanism 41 includes, as illustrated in FIG. 3, a first ring gear 41A, three first planet gears 41B, and a first planet carrier 41D, with the first pinion gear 32C (FIG. 2) as a sun gear, and is configured to have a speed reducing ratio of 5.0. The first ring gear 41A is configured in a coronary shape, provided with a plurality of projections around its outer circumference, arranged coaxially with the rotating axis of the motor 3, and fixed to the frame body 4A with the plurality of projections so as to be unable to revolve. The three first planet gears 41B are mounted rotatably, each having a first needle shaft 41C on the first planet carrier 41D. As the first planet gear 41B is mounted, the first planet carrier 41D is arranged inside the first ring gear 41A so that the three first planet gears 41B are each engaged with the first ring gear 41A. On a front surface of the first planet carrier 41D, a second pinion gear 41E projecting toward the front is arranged coaxially with the center axis of the first planet carrier 41D.

The second planetary gear mechanism 42 includes the second ring gear 42A, three second planet gears 42B, and a second planet carrier 42D, using the second pinion gear 41E as a sun gear, and is configured to have a speed reducing ratio of 2.0. The second ring gear 42A is arranged coaxially with the rotating axis of the motor 3, and has a string-shaped groove 42a around the circumference at a position near a rear end of an outer circumferential surface. At a front end position of the outer circumferential surface, a recessed part 42b is formed, which is open toward the front end and is a groove-shaped engaged unit extending in the longitudinal direction. This recessed part 42b is configured so as to be engaged with the convex part 23A. In the groove 42a, both ends of the engaging unit 27B formed in the approximately C shape are inserted. Since the groove 42a is formed in a string shape around the circumference, the second ring gear 42A is able to revolve with respect to the engaging unit 27B and moves forward and backward together with the engaging unit 27B. A position where the second ring gear 42A moves forward to cause the recessed part 42b to be engaged with the convex part 23A is defined as a holding position, and a position where the second ring gear 42A moves backward to cause the recessed part 42b to be separated from the convex part 23A is defined as a non-holding position. In FIGS. 1 and 2, the second ring gear 42A at the holding position is illustrated as a second ring gear 42A-1, and the second ring gear 42A at the non-holding position is illustrated as a second ring gear 42A-2.

The three second planet gears 42B are mounted on the second planet carrier 42D so as to be able to rotate with a second needle roller 42C, respectively. As the second planet gear 42B is being mounted, the second planet carrier 42D is arranged inside second ring gear 42A so that the three second planet gears 42B are each engaged with the second ring gear 42A.

As illustrated in FIG. 2, on a front surface of the second planet carrier 42D, a revolution supported unit 42E projecting toward the front is arranged coaxially with the center axis of the second planet carrier 42D, and the revolution supported unit 42E is revolvably supported by the anvil 6.

The hammer 5 is configured of paired pawl parts 51A. The paired pawl parts 51A are each arranged at the front surface of the second planet carrier 42D and at an outer circumferential position of the revolution supported unit 42E, projecting toward the front from a front end of the hammer 5, being arranged at positions 180 degrees away from each other around the axis, and being formed symmetrically to each other about the axis.

The anvil 6 is configured in a columnar shape extending in the longitudinal direction, and is revolvably supported by the hammer case 22 with the bearing 22A. At a rear end of the anvil 6, a bore 6a that is open toward the rear and formed by boring toward the front is provided. The revolution supported unit 42E fits in the bore 6a. In this manner, the revolution supported unit 42E is rotatably supported. At a front end portion of the anvil 6, a tip tool mounting unit 61 where a socket not shown is to be mounted is provided.

The tip tool mounting unit 61 is mainly configured of a plurality of balls 62 capable of projecting inside an insertion hole 6b formed at the front end of the anvil 6 and an operating unit 63 biased rearward by spring and abutting on the balls 62 as being pressed rearward to cause the balls 62 to project inside the insertion holes 6b to be engaged with a tip tool not shown. Wing parts 64 are integrally provided to a rear end surface of the anvil 6.

The wing parts 64 are arranged at positions 180 degrees away from each other about the center axis of the anvil 6, and are each formed in a shape symmetrical about the axis to be arranged at an outer circumferential position of the bore 6a. A rear end of each wing part 64 projects from the rear end surface of the anvil 6 toward the rear so as to be positioned at the rear of the front end surface of the pawl part 51A. The wing parts 64 are configured so that a distance in a radial direction from the center axis of the anvil 6 is equal to a distance of the pawl part 51A in a radial direction from the center axis of the second planet carrier 42D. With the pawl parts 51A abutting on these wing parts 64 in a circumferential direction, a rotary force about the axis is transmitted from the hammer 5 to the anvil 6. As the pawl parts 51A strongly are in contact with the wing parts 64, a revolving impact force from the hammer 5 is transmitted to the anvil 6.

Next, a relation between the control circuit unit 100 and the motor 3 will be described with reference to FIG. 4. The control circuit unit 100 includes a computing unit 110 as a microcomputer, a switching operation detection circuit 111, an applied voltage setting circuit 112, a revolving direction setting circuit 113, a current detection circuit 114, a rotator position detection circuit 115, a rotation angle detection circuit 116, and a deceleration switching detecting unit 117.

The switching operation detection circuit 111 detects whether the trigger 25 has been pressed, and outputs the detection results to the computing unit 110. The applied voltage setting circuit 112 sets a PWM duty of a PWM driving signal for driving any of the switching elements Q1 to Q6 of the motor driving circuit device 33 according to a target value signal outputted from the trigger 25, and then outputs the set duty to the computing unit 110. The revolving direction setting circuit 113 has the forward/reverse switching lever 25B connected thereto to define a revolving direction of the tip tool mounting unit 61. The current detection circuit 114 detects a current amount between the battery 7 and the motor driving circuit device 33. The rotator position detection circuit 115 detects a revolving position of the rotor of the motor 3 based on a revolving position detection signal outputted from a Hall IC 34, and then outputs the detection result to the computing unit 110. The rotation angle detection circuit 116 detects an angel of rotation of the motor 3 based on the detection result of the rotator position detection circuit 115. The deceleration switching detecting unit 117 detects whether the second ring gear 42A is at the holding position or the non-holding position, based on a signal output from the high/low detecting unit 27C. Specifically, when a signal output is inputted, it is detected that the second ring gear 42A-2 is positioned at the non-holding position. When no output signal is inputted, it is detected that the second ring gear 42A-1 is positioned at the holding position.

The computing unit 110 calculates a target value of a PWM duty based on an output from the applied voltage setting circuit 112. The computing unit 110 determines a stator winding for appropriate conduction based on an output from the rotator position detection circuit 115, and generates output switching signals H1 to H3 and PWM driving signals H4 to H6. The PWM driving signals H4 to H6 are each outputted with its duty width determined based on the magnitude of the target value of the PWM duty. A control signal output circuit 119 outputs the output switching signals H1 to H3 and the PWM driving signals H4 to H6 generated at the computing unit 110 to the motor driving circuit device 33.

The computing unit 110 controls the revolution of the motor 3 based on the output result from the deceleration switching detecting unit 117. The control has two types, that is, a High mode and a Low mode, corresponding to the non-holding position and the holding position, respectively. These modes will be described in detail further below.

Direct current power is supplied to the motor driving circuit device 33 from the battery 7. In the motor driving circuit device 33, a switching element is driven based on the output switching signals H1 to H3 and the PWM driving signals H4 to H6, thereby determining stator windings for conduction. Furthermore, the PWM driving signals are switched at the target value of the PWM duty. In this manner, a three-phase alternating voltage at an electrical degree of 120 degrees is sequentially applied to stator windings (U, V, and W) of three phases of the motor 3. Also, in the motor driving circuit device 33, the switching element can be driven so that the revolution of the rotor shaft 32A is stopped based on a signal from the computing unit 110 via the control signal output circuit 119.

The computing unit 110 includes a storage device 120, which is storage means such as a ROM. The storage device 120 functions as storage means storing various values in a flowchart, which will be described further below.

In the above-structured impact tool 1, a socket as a tip tool is mounted at the tip tool mounting unit 61. When a bolt or a nut is fastened, operability is superior with low toque and high-speed revolutions. Therefore, the operation knob 27A is operated to move toward the rear side to move the second ring gear 42A to the non-holding position at the rear. By this movement, the engagement between the convex part 23A and the recessed part 42b is released, and the second ring gear 42A is put into an unrestrained state and becomes able to revolve around the center axis. As the second ring gear 42A is made revolvable, deceleration by the second planetary gear mechanism 42 is not performed, and the number of revolutions of the second pinion gear 41E decreasing the number of revolutions of the first pinion gear 32C by the first planetary gear mechanism 41 for output becomes the number of revolutions of the tip tool mounting unit 61. Since the speed reducing ratio of the first planetary gear mechanism 41 is 5.0, the tip tool mounting unit 61 revolves at 15000/5=3000 rpm with respect to the number of revolutions of the motor 3 of 15000 rpm. With this, the tip toll mounting unit 61 can be revolved at high speed, thereby allowing a bolt or a nut to be fastened with excellent operability.

On the other hand, when a screw bit as a tip tool is mounted on the tip tool mounting unit 61 to fasten a tapping screw, operability is superior with low revolutions and high torque. Therefore, the operation knob 27A is operated to move toward the front side to move the second ring gear 42A to the holding position at the front. With this movement, the convex part 23A and the recessed part 42b are engaged with each other, and the second ring gear 42A becomes unable to revolve in a restrained state. With the second ring gear 42A becoming unable to revolve, the number of revolutions of the second pinion gear 41E is further decreased by the second planetary gear mechanism 42, and is transmitted to the tip tool mounting unit 61. Since the speed reducing ratio of the first planetary gear mechanism 41 is 5.0 and the speed reducing ratio of the second planetary gear mechanism 42 is 2.0, the tip tool mounting unit 61 can revolve at 15000/(5*2)=1500 rpm with respect to the number of revolutions of the motor 3 of 15000 rpm. In this manner, the tip tool can be revolved at a low speed with high torque, thereby allowing a tapping screw to be fastened with excellent operability.

As illustrated in diagrammatic drawings of FIGS. 5A and 5B, the impact tool 1 revolves the hammer 5 forwardly with slight reverse revolution so as to produce a revolving impact force. FIG. 5A illustrates a waveform of a current supplied to the motor 3 in the Low mode, and FIG. 5B illustrates a waveform of a current supplied to the motor 3 in the High mode. The operation of switching the current waveform is performed by the control circuit unit 100 controlling the PWM duty of the motor 3. For example, when the second ring gear 42A is set at the holding position, the PWM duty of the motor 3 is set as illustrated in FIG. 5A by the control circuit unit 100 so that an optimum impact force exerts as a Low mode. On the other hand, when the second ring gear 42A is moved to the non-holding position, the High mode is set, and the speed reducing ratio is decreased as compared with the state in which the second ring gear 42A is arranged at the holding position. Therefore, as illustrated in FIG. 5B, the amount of revolution of the hammer when the hammer 5 is revolved reversely is increased. Specifically, since the speed reducing ratio of the second planetary gear mechanism 42 is 2.0, when the hammer 5 is controlled so as to be revolved reversely at α° at the holding position, if similar control is performed at the non-holding position, the hammer 5 revolves reversely at 2.0 α°, which possibly inhibits a suitable impact from occurring. For this reason, the high/low detecting unit 27C detects the holding position or the non-holding position and, based on this detection result, the control circuit unit 100 sets an optimum PWM duty.

Specifically, as illustrated in a flowchart of FIG. 6, after the procedure starts and power is turned on at step S01, the procedure goes to step S02 to detect deceleration switching. Specifically, at step S03, it is determined whether the state is in the High mode or not, that is, whether the second ring gear 42A is at the non-holding position or not.

When a determination is made as No at step S03, the procedure goes to step S04, where the computing unit 110 calls Low mode control parameters from the storage device 120 to set the Low mode. Based on this setting, a forward revolution time T1 of the motor 3 is defined at step S05, a reverse revolution time T2 of the motor 3 is defined at step S06, and a current threshold I1 to be applied to the motor 3 is defined at step S07. After these values are defined at steps S05 to S07, the procedure goes to step S08, waiting in the state of being able to drive the motor 3 with an operation of the trigger 25.

On the other hand, when a determination is made as Yes at step S03, the procedure goes to step S09, where the computing unit 110 calls High mode control parameters from the storage device 120 to set the High mode. Based on this setting, a forward revolution time T1′ (=T1/G1) of the motor 3 is defined at step S10, a reverse revolution time T2′ (=T2/G1) of the motor 3 is defined at step S11, and a current threshold I1′ (=I1*G1) to be applied to the motor 3 is defined at step S12. Here, G1 indicates the speed reducing ratio of 2.0 of the second planetary gear mechanism 42 described above. After these values are defined at steps S10 to S12, the procedure goes to step S08, waiting in the state of being able to drive the motor 3 with an operation of the trigger 25.

The rotation angle of the hammer 5 is directly proportional to the revolution time and reversely proportional to the speed reducing ratio when the angular velocity of the rotor shaft 32A in the motor 3 is constant. Therefore, while the speed reducing ratio is twice in the High mode as much as in the Low mode, the forward revolution time T1′ and the reverse revolution time T2′ are half of those in the Low mode. Therefore, the rotation angle of the hammer 5 in the High mode is equal to that in the Low mode.

The running torque of the hammer 5 is increased so as to be directly proportional to the speed reducing ratio when the running torque of the rotor shaft 32A in the motor 3 is constant. Therefore, while the running torque in the High mode is half of that in the Low mode, the running torque of the rotor shaft 32A is doubled with the current threshold Il being doubled. Thus, the running torque of the hammer 5 in the High mode is equal to that in the Low mode.

By setting T1′, T2′ and I1′ in this manner, a change between the feeling of impact in the High mode and the feeling of impact in the Low mode can be decreased to improve operability of the impact tool 1.

In the impact tool 1 according to the present embodiment, by moving the second ring gear 42A, which is one ring gear, to the holding position or the non-holding position, the speed reducing ratio can be easily changed. This movement can be also easily performed with the operating unit 27, and the second ring gear 42A can be easily switched between the holding position and the non-holding position.

Since the motor 3 is a brushless motor, its revolution control is easy. Therefore, the characteristic of the motor 3 can be switched between the Low mode and the High mode at the holding position and the non-holding position, respectively, thereby achieving optimum control. Also, by adopting a brushless motor, for example, the forward rotation angle and the reverse rotation angle of the hammer 5 may be continuously calculated from the signal from the Hall IC 34 of the motor 3 and the speed reducing ratio, and a forward revolution signal and a reverse revolution signal to be applied to the motor 3 may be subjected to feedback control so that the forward rotation angle and the reverse rotation angle of the hammer 5 are reversely proportional to an increase in the speed reducing ratio. According to this feedback control, more accurate impact timing can be obtained. In particular, the control becomes effective when the number of revolutions of the motor 3 is not constant.

Since the holding position or the non-holding position is detected by the high/low detecting unit 27C from the operation of the operation knob 27A, the holding position or the non-holding position can be easily detected. Note that, as this detection, the position of the second ring gear 42A may be directly detected.

In the present embodiment, as one ring gear moving between the holding position and the non-holding position, the second planetary gear mechanism 42 is set, which is positioned most downstream among the plurality of planetary gear mechanisms included in a motive power transmitting route where the motor 3 is located most upstream and the anvil 6 is located most downstream. The second planetary gear mechanism 42 has the number of revolutions of the gear in the structure of the mechanism lower than the number of revolutions of the gear in the structure of the first planetary gear mechanism 41, and therefore the convex part 23A and the recessed part 42b can be easily engaged with each other. In this manner, the second ring gear 42A can easily move between the holding position and the non-holding position.

While the impact toll of the present embodiment includes two planetary gear mechanisms, it is not limited to this, and the present invention can be applied to an impact tool including, for example, three planetary gear mechanisms. Also, while a switching operation regarding deceleration is performed on only one ring gear, the switching operation regarding deceleration can be performed further on another ring gear.

### INDUSTRIAL APPLICABILITY

This impact tool is used to provide an impact force to a screw member to fasten the screw member to a fastened member.

1. An impact tool by comprising:
a motor;
a hammer to be driven by the motor for revolution;
an anvil impacted with the revolution by the hammer and transmitting an impact force to a tip tool;
a plurality of planetary gear mechanisms interposed between the motor and the hammer, each having a ring gear, and transmitting a rotary force of the motor to the hammer; and
a housing holding the motor, the hammer, the anvil, and each of the ring gears, at least one ring gear among the ring gears being movable to move between a holding position where the ring gear is engaged with and held by the housing and a non-holding position where the ring gear is not engaged with the housing and is revolvable with respect to the housing.

2. The impact tool according to claim 1,
wherein the housing of the impact tool has an engaging unit engaging with the one ring gear;
the one ring gear has an engaged unit engaging with the engaging unit; and
the engaging unit and the engaged unit are configured so as to be engaged with each other at the holding position and become unable to be engaged with each other at the non-holding position.

3. The impact tool according to claim 1,
wherein the impact tool further comprises an operating unit capable of operating the ring gear between the holding position and the non-holding position; and
the operating unit is exposed to an outer surface of the housing

4. The impact tool according to claim 1,
wherein the ring gear is preferably included in a planetary gear mechanism that directly drives the hammer for revolution among the plurality of planetary gear mechanisms.

5. The impact tool according to claim 1,
wherein the motor is a brushless motor;
the impact tool further includes a control unit for revolution control over the motor; and
the control unit is configured to be able to change the revolution control with the one ring gear being provided at the holding position and the non-holding position, respectively.

6. The impact tool according to claim 5,
wherein the impact tool further comprises a detecting device that detects a position of the one ring gear at the holding position and the non-holding position; and
the control unit performs the revolution control based on the detection result of the detecting device.
